(19) United States
(12) Patent Application Publication
(10) Pub. No.: US 2024/0358575 A1
(43) Pub. Date: Oct. 31, 2024

(54) IMPROVED SYSTEM FOR GASTROINTESTINAL HEALTH

(71) Applicant: Franklin R Lacy, Marco Island, FL (US)

(72) Inventor: Franklin R Lacy, Marco Island, FL (US)

(21) Appl. No.: 18/141,158

(22) Filed: Apr. 28, 2023

(51) Int. Cl. A61H 1/00; A61H 23/02

(52) U.S. Cl. CPC A61H 1/005; A61H 23/02; A61H 2203/0456

(57) ABSTRACT

A vibrating platform with a plurality of body contact members which vibrate as the vibrating platform vibrates, the contact members being arranged into an array which makes contact with a patient's body over an area defined by the dimension of the small and large intestines over the patient's body and vibrate the muscles controlling digestive action, including disease control, when the contact members contact the exterior of the human body.

### TECHNICAL FIELD

This invention relates generally to systems and/or appliances operative to improve gastrointestinal health and more particularly treat the entire intestinal system at once, including both large and small intestines.

### BACKGROUND OF THE INVENTION

The effects of aging are well recognized. Bodily functions, for instance, slow down and sometimes body parts malfunction. In the gastrointestinal system as shown in FIG. 1, food moves down the esophagus through the esophageal sphincter muscle into the stomach and from there enters the first parts of the small intestine e.g., the duodenum 10 and the jejunum 12 and then through the final portion of the small portion of the small intestine, the ileum 14, and then through the colon, the large intestine 16. The unabsorbed remaining portion of the food is evacuated through the rectum 18. During this process, nourishment is absorbed into the bloodstream; a plurality of mostly involuntary nerve sensors control the process. This includes the ring muscles and the longitudinal muscles in the digestive tract, controlled by nerves all up and down the digestive tract, which consists of 22′ of small intestine and 5′ of large intestine. Nutrients and toxins travel through the digestive tract. Villi which line the intestines pick up nutrients, liquids and enzymes from movement into the vascular system. This includes toxins, viruses and bacterial infection as well.

The clamping muscles and longitudinal muscles around the intestines work at different rates for different people. However, the digestive muscles tend to move slower as aging progresses. Also, processed food typically moves more slowly and stays in the gastrointestinal system longer. The result is greater absorption of nutrients from the same quantity of food as well as deterioration of the quality of the food moving through the gastrointestinal tract. This tends to produce a weight gain and a buildup of toxins in the blood for the same amount of food eaten, resulting in a potential source of disease and inflammation of many organs including the heart, the brain, the skin, the eyes and the lungs. The present invention is directed toward improving gastrointestinal health by energizing intestinal action of both large and small intestines.

### SUMMARY OF THE INVENTION

Accordingly, the invention is an appliance for improving gastrointestinal health comprising: a powered arrangement adapted for exercising the muscles controlling the digestive action of the small and large intestines of the human body.

### BRIEF DESCRIPTION OF THE DRAWINGS

FIG. 1 illustrates the human intestinal system, including a small intestine approximately 22 feet followed by a large intestine approximately 5 feet.

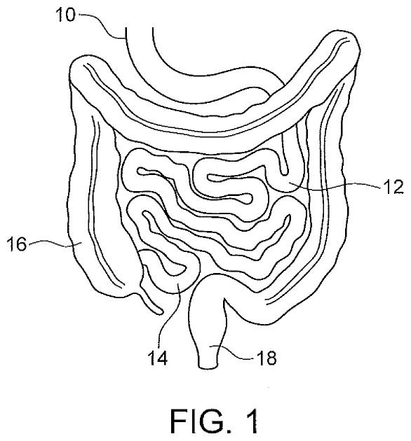

FIG. 2 is a perspective view of the system/appliance of the present invention showing one vibrator element arrangement.

FIG. 3 is a perspective view of the present invention showing the power connections to the system/appliance with another vibrator element arrangement.

FIG. 4 is an exploded view of a vibrator element of the system/appliance of FIGS. 2 and 3.

### BEST MODE FOR CARRYING OUT THE INVENTION

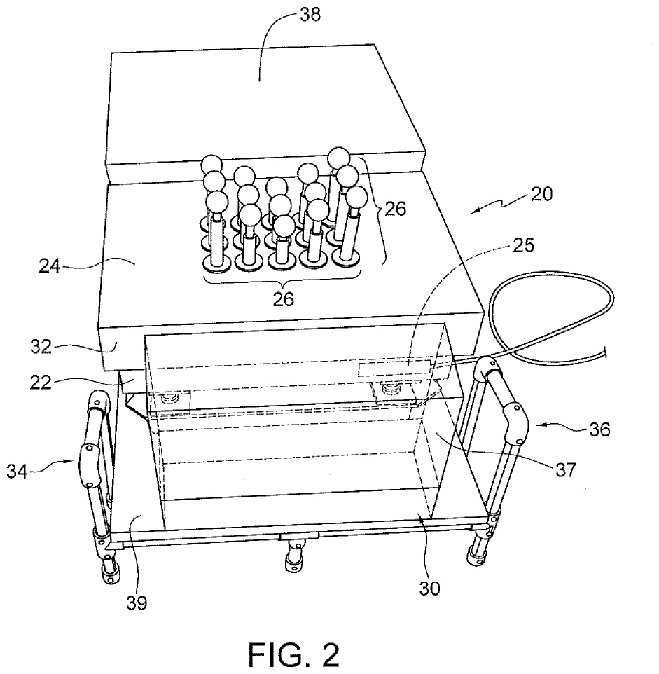

FIG. 2 is a perspective view of the system/appliance of the present invention, shown generally at 20 with one vibrator element arrangement. The system/appliance includes a base platform or unit 22 and a vibrating platform 24, which is positioned on top of the base platform. In this embodiment, base platform 22 is made from a rigid material such as metal, plastic or wood. Platform 22 is approximately 24 inches wide by 14 inches long by 7.5 inches high with handles on opposing longitudinal ends, not shown in FIG. 2. The vibrating platform 24 is slightly larger and is positioned operatively on the upper surface of the base platform 22. A vibrating source 25 is bolted to the base platform 22 and vibrates the vibrating platform 24. Mounted in the vibrating platform 24 and extending upward therefrom in FIG. 2 are a plurality of vibrator elements or posts 26-26. The arrangement of the vibrator elements can vary depending upon the intestinal area to be treated as well as the configuration of the patient's body area adjacent the small/large intestines. Two embodiments of the vibrator arrangements are discussed below as examples of a variety of vibrator arrangements.

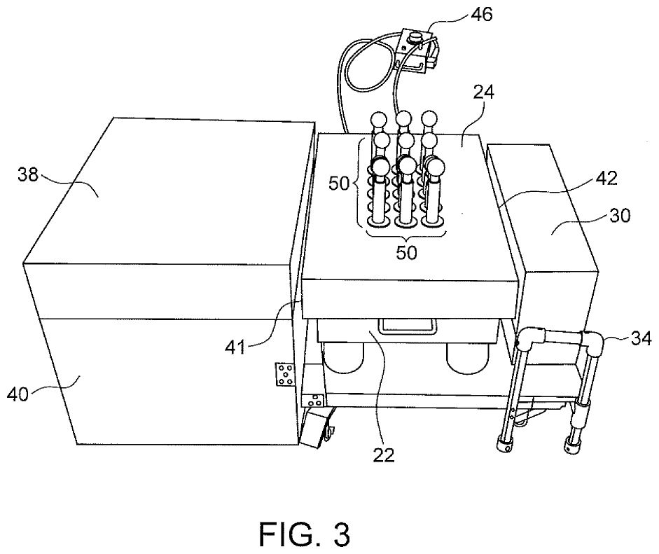

The appliance shown in FIGS. 2 and 3 includes a rearward unit 30 positioned adjacent a rearward edge surface 32 of the vibrating platform 24. The rearward unit 30 includes two handles 34 and 36 on opposing ends, for use by a patient who is using the appliance. The rearward unit can include multiple (1-5) cushions 37 and a cushion platform 39 for kneeling. Handles 34 and 36 are configured so as to support the cushion platform 39. Various handle configurations can be used. Each handle in the embodiment shown includes a horizontal top element approximately 4.5 inches long and two side elements which extend downwardly from the respective ends of the top element to the ground.

The appliance also includes an upper body forward cushion 38 which is positioned in a box container 40, shown in the embodiment of FIG. 3, positioned against a front edge surface 41 of the vibrating platform 24. The box 40 and the cushion 38 are configured so that cushion 38 extends a short distance i.e., one inch or so, above the surface of the vibrating platform 24. In typical use, the patient lays down on the appliance, e.g., kneeling on the rearward cushions 37, laying on the vibrating platform 24 and the forward cushion 38 so that the individual vibrator elements contact the body surface of the patient slightly below the rib line. In another embodiment, forward cushion 38 and box 40 could be on both edge surfaces 41 and 42 of the vibrating platform 24.

Various vibrator arrays can be utilized. In the particular arrangement of FIG. 2, there are five adjacent parallel rows of vibrators 26-26 with the vibrating array arranged into parallel columns of vibrators. The two columns of vibrators on the outside of the array are the longest, approximately 5.5 inches high. The two columns of vibrators positioned inwardly from the outside columns of vibrators are slightly shorter, approximately 4.5 inches. The single inner vibrator is approximately 3.5 inches high. In this arrangement, the width of the vibrator array is 10 inches and the depth of the array is 5 inches. As indicated above, the individual vibrators are supported in the vibrating platform 24, which is vibrated in the embodiment shown at a frequency range of 10-50 Hz and an amplitude range of 0.03-0.12 inches. An on/off control 46 controls the application of vibration power to the vibrating platform.

FIG. 3 shows a slightly different arrangement of vibrators 50-50 comprising three parallel lines of vibrators, with each line of vibrators comprising three parallel columns of vibrators, for a total of nine vibrators in this arrangement. All vibrators have the same length.

It should be understood that other vibrator arrays can be used, depending upon the desired vibration pattern. Generally, the array is configured in columns and rows so as to cover the interior gastrointestinal tract region, without impinging on the ribs of the user.

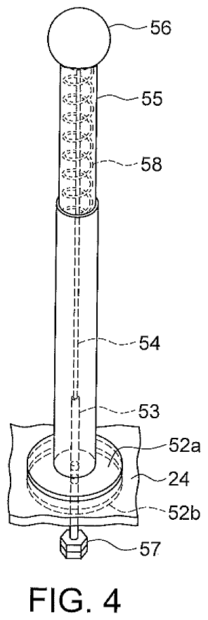

Referring now to FIG. 4, the vibrators have a first flexible lower base member 52a and a second flexible lower base member 52b, with the upper part of the vibrating platform 24 therebetween. An outer cylindrical member 54 is attached to the first lower base member 52a. An inner cylinder member 55 is attached to top cushioned skin contact member 56. A threaded rod 53, which rigidly contacts the top member 56, extends through the center of inner spring(s) 58 from the flexible lower base member 52a. Locknuts 57 secure the lower base member 52a, the upper part of the vibrating platform and the lower base member 52b securely together. The inner spring(s) 58 have one or more spring constant(s) which compensate for different size and weight of patients.

In operation of the appliance, as outlined above, the patient lies on the appliance so that the top members of the vibrators rest against the user but do not hit the rib bones. The power control 46 is operated to begin the vibration of the vibrating platform 24, vibrating the individual vibrators. The vibrations of the vibrators in operation move the large intestine vertically as well as horizontally. The small intestine also is vibrated. This results in the involuntary nerves controlling the muscles of the large intestine and small intestine being energized, which results in strengthening of and increasing the quickness of operation of the large and small intestines, just as exercising other muscles of the body improves the action and capability of those muscles. This results in food, toxins, viruses and bacterial infections moving through the gastrointestinal tract more rapidly, thereby improving the overall health of the individual, by reducing the time food, toxins, viruses and bacterial infections spends in the gastrointestinal tract, thereby reducing the amount absorbed in the blood by the villi. This appliance has in use been indicated to improve the gastrointestinal health of the individual with short term treatments of 15 minutes, or somewhat longer, at regular intervals, or as short as once per year to produce the desired results.

Accordingly, an appliance has been designed to improve the gastrointestinal health of patients used for short time periods at selected intervals, in some cases, once a year but in other cases somewhat more regularly.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. An appliance for improving gastrointestinal health comprising:
a powered arrangement adapted for exercising the muscles controlling the digestive action of the small and large intestines of the human body.

2. The appliance of claim 1, wherein the powered arrangement includes a vibrating platform or source of vibration and a plurality of vibrators supported by and extending from the vibrating platform or source of vibration.

3. The appliance of claim 2, wherein the plurality of vibrators are arranged in an array which vibrate the muscles controlling digestive action of the large and small intestines when the vibrators contact the exterior of the human body, stimulating interior members or parts of the human body.

4. The appliance of claim 3, wherein the array of vibrators make contact with the physical area of the body defined by the small and large intestines without coming into contact with the ribs of the user.

5. The appliance of claim 3, wherein the vibrators are in the form of posts having an upper end adapted for external contact with the human body.

6. The appliance of claim 3, wherein the vibrators operating in response to the source of vibration include spring elements which are adapted to accommodate different patient size and weight.

7. The appliance of claim 5, wherein the posts are arranged in rows and column to form the array.

8. The appliance of claim 1, wherein the vibrations have a frequency range of 10-50 Hz and an amplitude range of 0.03-0.12 inches.

9. The appliance of claim 5, including cushions in front of and to the rear of the vibrating platform.

10. The appliance of claim 5, wherein the array of vibrators comprises two outer columns of posts, two inner columns of posts and a single inmost post, wherein the outer columns of posts are taller than the inner columns of posts, which are taller than the single innermost post.

11. The appliance of claim 5, wherein the posts are all of equal height.
